(19) United States
(12) Patent Application Publication
(10) Pub. No.: US 2026/0147809 A1
(43) Pub. Date: May 28, 2026

(54) SAFE AND ASSURED CONVERSATIONAL ARTIFICIAL INTELLIGENCE SYSTEM BASED ON MULTI-AGENT LARGE LANGUAGE MODELS

(71) Applicant: THE BOEING COMPANY, Arlington, VA (US)

(72) Inventors: Alexander Bellemare-Davis, Vancouver (CA); Ying Xiong, Vancouver (CA); Soheil Seyyedi Parsa, Vancouver (CA); Yiping Huang, Vancouver (CA); Deyi Wang, Vancouver (CA); Yadong Liu, Vancouver (CA); Anni Sarah Langille, Coquitlam (CA)

(73) Assignee: THE BOEING COMPANY, Arlington, VA (US)

(21) Appl. No.: 18/961,891

(22) Filed: Nov. 27, 2024

(51) Int. Cl. G06F 16/334; G06F 16/338

(52) U.S. Cl. CPC G06F 16/3344; G06F 16/338

(57) ABSTRACT

An artificial intelligence system includes a generative LLM that receives prompts related to maintenance of a powered system. The generative LLM identifies one or more function tools for searching for information responsive to the prompt. The system also includes one or more discriminative LLMs trained on maintenance logbooks and technical manuals. The generative LLM selects from among the one or more discriminative LLMs to search for the information responsive to the prompts based on which of the function tools are identified. The discriminative LLMs that are selected obtain the information responsive to the prompts and to provide the information to the generative LLM. The generative LLM creates and presents responses to the prompt according to a pattern associated with the function tools that are identified and using the responsive information.

### BACKGROUND

### Field of the Disclosure

Examples of the present disclosure generally relate to artificial intelligence (AI) systems and methods that use multiple large language models (LLMs) to safely respond to prompts related to technical and/or maintenance information for various powered systems.

### Description of the Art

Repairing, inspecting, and/or maintaining equipment may require referring to a variety of sources of information, such as general information regarding the type (e.g., make and/or model) of the equipment and individualized information regarding the exact equipment being repaired, inspected, and/or maintained. The general information can include different technical publications, images, and/or videos describing procedures and/or providing visual information for the personnel performing the repair, inspection, and/or maintenance. The individualized information can include historical information such as maintenance logs, personnel notes related to the equipment, usage logs, etc.

Various search tools exist for allowing these personnel to search through these sources of information to obtain the information needed to complete the repair, inspection, and/or maintenance of the equipment. These include text and/or vocal searches of different databases, as well as usage of conversational generative AI-based systems, such as retrieval augmented generation (RAG) frameworks that rely on large language models (LLMs). These conversational generative AI-based systems can allow for personnel to submit inquiries in a more conversational way (as opposed to text searching), with the systems searching many information sources and creating conversational responses based on prompts.

When constructing generative LLMs (especially for the purposes of conversational interfaces), however, problems can arise. One problem is that generative LLMs can be susceptible to providing less helpful responses, such as responses that do not provide a level of detail needed to complete a task or fully respond to a prompt. For example, an aircraft mechanic may provide the prompt “summarize recent recurrent maintenance on tail number 12345” to a generative LLM and receive the response “the oxygen systems on tail number 12345 have received frequent maintenance recently.” Such a responses may not be helpful or aiding the mechanic in performing maintenance on the aircraft, as the mechanic may require more specific information, such as the dates when maintenance was performed on the aircraft, details on maintenance of other systems (aside from the oxygen systems), etc.

Another problem with generative LLMs can be hallucinations. For example, a generative LLM can provide a response to a prompt that appears to be an accurate, responsive answer to the prompt. But the response may include fabricated details, such as fabricated dates that maintenance was or was not performed, fabricated operations performed on a powered system, or the like.

Another problem with generative LLMs can be inconsistent formats in which output is provided. For example, the same generative LLM may provide answers to the same prompt in different formats. This can cause confusion to users, require users to repeatedly provide the prompt until the response is provided in a desired or helpful manner, or the like.

To avoid these types of inefficient and unhelpful responses, some known generative LLM systems may require considerably more training of users to optimally phrase the prompts. But this can increase the time and cost of implementing and operating generative LLM systems, and not all users may continue using optimal prompts.

### BRIEF SUMMARY

In another example, an artificial intelligence system includes a generative LLM configured to receive prompts related to maintenance of one or more components of a powered system. The generative LLM is configured to identify one or more function tools to be used in searching for information responsive to the prompts. The artificial intelligence system also includes one or more discriminative LLMs trained on maintenance logbooks and technical manuals associated with the one or more components of the powered system. The generative LLM is configured to select from among the one or more discriminative LLMs to search for the information responsive to the prompts based on which of the one or more function tools are identified. The one or more discriminative LLMs that are selected are configured to obtain the information responsive to the prompts and to provide the information to the generative LLM. The generative LLM is configured to create and present responses to the prompts according to a pattern associated with the one or more function tools that are identified and using the responsive information.

In another example, a method includes receiving a prompt related to maintenance of one or more components of a powered system. The prompt is received by a generative LLM. The method also includes identifying one or more function tools to be used in searching for information using the generative LLM. The one or more function tools are identified based on the prompt. The method also includes assigning one or more discriminative LLMs to search maintenance logbooks and technical manuals associated with the one or more components of the powered system based on the one or more function tools that are identified, and creating a response to the prompt according to a pattern associated with the one or more function tools that are identified and using the responsive information.

In another example, an artificial intelligence system includes a generative LLM configured to receive a prompt related to maintenance of a component of an aircraft. The generative LLM is configured to identify a function tool to be used in searching for information responsive to the prompt. The artificial intelligence system also includes one or more discriminative LLMs trained on maintenance logbooks and technical manuals associated with the component of the aircraft. The generative LLM is configured to select from among the one or more discriminative LLMs to search for the information responsive to the prompt based on which of the one or more function tools are identified. The one or more discriminative LLMs are configured to obtain the information responsive to the prompt using the function tool that is identified and to provide the information to the generative LLM.

### BRIEF DESCRIPTION OF THE DRAWINGS

FIG. 1 illustrates one example of an AI system.

FIG. 2 includes a graphical user interface (GUI) that may be presented on an electronic display device of an interface shown in FIG. 1.

FIG. 3 illustrates a flowchart of one example of a method for operating the AI system shown in FIG. 1.

FIG. 4 illustrates one example of an LLM.

### DETAILED DESCRIPTION

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

One or more examples of the inventive subject matter described herein provide an AI system having a generative LLM with several functions or tools specifically designed for particular or designated types of questions, such as maintenance questions, aircraft questions, or aircraft maintenance questions. These function tools effectively recognize when a question or prompt is of a certain type (e.g., “summarize recent recurrent maintenance on tail number 12345”) and ensure that the resulting answer provided by the AI system follows or is provided according to a pre-determined pattern to be useful and actionable for that person. For example, the AI system may recognize certain words or phrases in the prompt (e.g., keywords), identify which of several different prompt patterns these words or phrases are associated with, obtain the information needed to respond to the prompt, and provide an answer according to a response pattern that ensures that certain information (e.g., a minimum level or amount of detailed information) is provided based on the response pattern. This can ensure that users receive the necessary amount of information with specific details without having to require the users to always provide a certain, specific prompt to obtain this information.

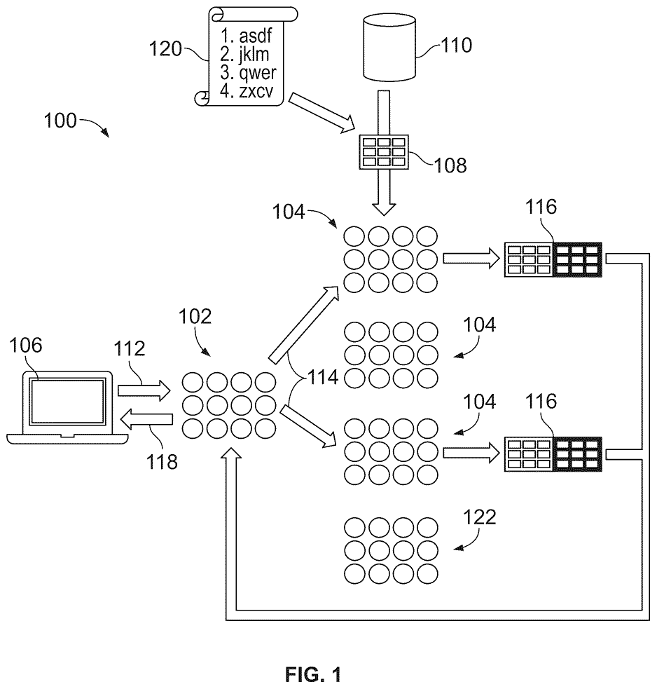

FIG. 1 illustrates one example of an AI system 100. The AI system 100 can include a generative LLM 102 and one or more discriminative LLMs 104. Each of the LLMs 102, 104 can represent a trained artificial neural network (ANN) that performs different tasks. The generative LLM 102 can be referred to as an orchestration agent as the generative LLM 102 receives prompts from users, receives relevant responses from the discriminative LLM(s) 104, and formulates and presents answers to the users based on the responses. While three discriminative LLMs 104 are shown, optionally, there may be fewer discriminative LLMs 104 or more than three discriminative LLMs 104.

The AI system 100 can be referred to as a multi-agent AI system 100 having trained or fine-tuned discriminative LLMs 104 that pre-process data on the backend of the AI system 100. The discriminative LLMs 104 can be trained on information and data relevant to various components of a powered system (e.g., an aircraft, other aviation equipment, another vehicle, or another system that is not a vehicle). The discriminative LLMs 104 can receive tasks from the generative LLM 102, with the tasks based on prompts or queries received by the generative LLM 102. The discriminative LLMs 104 can analyze the tasks in view of the training data used to train the discriminative LLMs 104 and provide outcomes of the analyses to the generative LLM 102. The generative LLM 102 can manage a conversational interface with users of the AI system 100. The AI system 100 may be used in a maintenance shop for the powered system, and maintenance personnel can provide input 112 in the form of text, speech, images, videos, etc. to the generative LLM 102 via a computer interface 106. The computer interface 106 can include one or more input and/or output devices, such as a computer, a phone, a microphone, a keyboard, a touchscreen, etc.

The input 112 can include queries or prompts regarding maintenance or inspection of the powered system or components of the powered system. The generative LLM 102 can examine the prompts for certain words or phrases associated with a prompt pattern. For example, different words or phrases in different prompts may be associated with different prompt patterns. Inclusion of a unique identification of a powered system (e.g., an aircraft tail number) in a prompt may be identified by the generative LLM 102 and associated with one prompt pattern, the name of a component of the powered system (e.g., a brake system) may be associated with another prompt pattern, the words “maintenance,” “replace,” etc. in prompts may be associated with different prompt patterns, and the like. The associations between the words or phrases in the prompts and the different prompt patterns may be stored in the generative LLM 102, such as in the synaptic circuits or the weights within the generative LLM 102.

Once the prompt pattern is identified by the generative LLM 102, the generative LLM 102 can decide what information is to be obtained and provided in the response to the prompt. For example, different prompt patterns may be associated with different executive agents and their corresponding function tools. The function tools include a group of functions that can be called to run queries on data, such as maintenance logbook data. The generative LLM 102 can search for the corresponding function tools to process the logbook data and return the processed schema. Then the processed schema can be passed to the generative LLM 102 for summarizing in a response to the user prompt. Each function tool can be used to obtain different information (e.g., from one or more discriminative LLMs 104 or other sources) for responding to the prompt.

One function tool can be a component function tool. When used, this tool can obtain maintenance records on a specific component of a powered system that is identified in the prompt, can provide the most recent actions performed on the identified component, can provide the conditions of the component for the most recently performed actions, can provide relevant records regarding the identified component during a designated time period, etc.

For example, a prompt provided to the generative LLM 102 may identify a main cabin oxygen unit for an aircraft identified by tail number. The generative LLM 102 can identify the component as a main cabin center oxygen passenger service unit based on the prompt including “main cabin oxygen unit,” may identify the aircraft by the tail number included in the prompt, and may determine that the component function tool is to be used to provide the response due to including this information in the prompt. As described below, the generative LLM 102 can then assign analysis tasks to discriminative LLMs 104 to obtain information responsive to the prompt based on this function tool.

Another function tool can be a condition function tool. When used, this tool can obtain information on the conditions of the aircraft and/or components of the aircraft during recent flights. The conditions can be the top conditions in recent flights, the output of the aircraft or components, the state or health of the aircraft or components, the load placed on components, etc. The generative LLM 102 can decide to use this tool responsive to the prompt identifying the aircraft and/or components, and asking about the state, operation, or health of the aircraft or components.

Another function tool can be an action function tool. This tool can obtain top or recent actions or events, or deferrals of such actions or events, performed or occurring during recent flights, with or without components. The generative LLM 102 can decide to use this tool responsive to the prompt identifying or requesting information on events that occurred during an identified flight or involving an identified aircraft or component.

Another function tool can be a recurrence summary tool. This tool can provide information about how often (e.g., a frequency) at which some event occurred involving the aircraft or components of the aircraft, the frequency at which maintenance was performed on a component, or the like. The generative LLM 102 can decide to use this tool when the prompt includes language asking about how often an event occurred or was repeated, such as “how often were passenger seats on aircraft tail number 98765 deferred?”

A function tool used by the generative LLM 102 can be a minimum equipment list (MEL) summary. The tool can be used to return maintenance records, logbook records, or other records or information related to components included in the MEL for an aircraft. The generative LLM 102 can decide to use this tool to obtain information related to the components on the MEL for a designated time period responsive to receiving a prompt that refers to the MEL or to one or more components included in the minimum equipment list.

Another function tool can be a sensor warning tool. The generative LLM 102 can use this tool responsive to the prompt asking about or including information regarding a sensor output, such as a detected characteristic of the aircraft or component, an alarm from the sensor, or the like. For example, a prompt asking about a low oil pressure alarm may cause the generative LLM 102 to use the sensor warning tool to obtain the characteristic measured by a sensor giving rise to the warning or alarm, historical values of the sensor output (e.g., the measured characteristics), a history of the sensor alarm occurring, limits used by the sensor to determine when to output the alarm, remedial information or instructions on steps to perform to stop the alarm or repair the issue giving rise to the alarm, etc.

A function tool can include an estimated work time tool. This tool can be used by the generative LLM 102 to obtain the times needed to perform maintenance or repair on one or more components, such as the duration of maintenance or repairs previously performed on the same component or similar component (same component used in a different aircraft). The generative LLM 102 can decide to use this tool responsive to the prompt including words or phrases asking the duration of maintenance or repair actions or how long to complete maintenance or repair actions.

Another function tool can include a maintenance history tool. This tool can be used by the generative LLM 102 when a prompt includes language inquiring for prior maintenance performed on a component. For example, the tool may be used responsive to receiving a question such as “when was the last time the main cabin door was inspected?” The generative LLM 102 can use this tool to obtain information related to prior maintenance on the identified component, such as information from maintenance logbooks.

Another function tool can include an inventory tool. This tool can be used by the generative LLM 102 when a prompt includes language inquiring about the availability for a component (or part of a component). For example, a prompt may ask whether a replacement audio jack for an aircraft is available, or how many are available. The generative LLM 102 can then obtain information on the component availability, such as from an inventory table.

The generative LLM 102 can use a troubleshooting function tool responsive to a prompt asking for assistance in finding a cause for a fault of a component. The generative LLM 102 can use this tool to obtain information from technical manuals, maintenance logbooks, maintenance history tables, or the like, and provide step-by-step instructions on finding the cause for the component fault.

Once the tool or tools are selected by the generative LLM 102 based on language in the prompt, the generative LLM 102 can select which of the discriminative LLMs 104 are to search for and return information responsive to the prompt. For example, the generative LLM 102 can direct certain discriminative LLMs 104 to search through labeled data 108, such as maintenance logbooks, technical manuals, etc. for responsive information. Different discriminative LLMs 104 may be associated with different review the labeled data 108 for responsive information, and return this responsive information to the generative LLM 102 as output 116.

The generative LLM 102 may examine the output 116 from the discriminative LLMs 104 and create a response 118 to the queries or prompts in the input 112. This response 118 can then be presented to the personnel via the interface 106 (or via another interface 106). The response 118 that is provided may be confined to a defined format, or pattern. The pattern that is selected by the generative LLM 102 may be selected based on which function tools are selected for obtaining the information to respond to the prompt. For example, usage of the component tool may cause the generative LLM 102 to display a list of the prior maintenance records on the component identified in the prompt. Usage of the condition tool may cause the generative LLM 102 to display a table listing the conditions and the associated flights and/or components (e.g., the flights or components in one column, and the conditions in another column). Usage of the maintenance history tool may cause the generative LLM 102 to list portions (but not the entirety) of maintenance logbooks, with the listed portions being restricted to the component identified in the prompt. Additionally, the generative LLM 102 can limit the portions that are listed to a defined time period, such as a time period identified in the prompt or a designated time period (e.g., one year).

The generative LLM 102 can provide the response 118 as a list of a designated number (e.g., five or another number) of sensor alarms, along with the date and/or time, and the sensor readings giving rise to the alarms, responsive to the sensor warning tool being used. The generative LLM 102 can provide the response 118 as a table of available components, as well as the locations of the components, in response to the inventory tool being used.

The generative LLM 102 can use the same pattern for all responses 118 obtained using the same tool to ensure that the information provided to the user is consistent. This can prevent an insufficient amount of information from being displayed (e.g., by stating the number of sensor alarms instead of merely stating that the sensor alarm has been generated frequently). This also can ensure that users consistently see the information presented in the responses 118 in a common way based on the tool used, which can help the users to quickly comprehend the information.

The discriminative LLMs 104 can represent LLMs that are trained with information (e.g., the labeled data 108) from one or more computer readable, non-transitory memories or databases 110. In one example, multiple databases 110 may be used, with each database 110 having information relative to a different domain (e.g., maintenance of particular components or powered systems, such as aircraft and associated equipment). The LLMs 102, 104, interface 106, and database 110 may be connected with each other and can communicate with each other via or over wired and/or wireless connections.

The discriminative LLMs 104 can be trained on the labeled data 108, which can represent technical documents, maintenance logs of components, technical manuals of the components, and the like. Including the discriminative LLMs 104 in the AI system 100 can address some weaknesses of other known generative LLM-based AI systems. These weaknesses include difficulties in measuring the accuracy of the responses from the generative LLMs and reduced security of the labeled data 108 stored in and/or used to train the generative LLMs.

Some of these known generative LLM architectures include a double-tiered transformer architecture having encoders followed by decoders. The encoders and decoders are algorithmic structures of the LLMs that process and transform input into formats that are understandable to the LLMs and can be manipulated by the LLMs. The encoders process input received by the generative LLMs, and identify meanings or representations within the input based on the labeled data used to train the generative LLMs. The encoders examine each word or token, and generate compressed representations of the input. The decoders receive these compressed representations and can iteratively generate words or tokens using previous outputs from the decoders and the compressed representations as inputs. The output from the decoders can be text based on the previously generated tokens.

But these generative LLMs may not be limited to usage of certain labels in identifying similarities between the prompts and the data used to train the generative LLMs. Consequently, the decoders may generate a wide range of responses. This can make the accuracy of the responses more difficult to measure, and can pose a security risk of disclosing the secret or confidential information stored in and/or used to train the generative LLMs. For example, engineered prompts are inputs crafted to guide or attempt to guide the generative LLMs to provide a desired output. If the generative LLMs are trained with confidential or secret information, then bad actors can create prompts that cause the generative LLMs to output at least some of the secret or confidential information.

In contrast, the discriminative LLMs 104 of the AI system 100 described herein can include only a single tier architecture of the encoders. This single tier of encoders does not include decoders. The encoders can process the input 112 (via the assigned tasks 114) in a single pass instead of a first pass through the encoders and a subsequent pass through the decoders in two tier architectures of some generative LLMs. The encoders of the discriminative LLMs 104 can map text (or token) sequences from the tasks 114 assigned by the generative LLM 102 to text (or token) sequences using a single recurrent neural network (NN) or transformer architecture. While this architecture of a single tier of encoders can understand the text, speech, image, or video input 112, the encoders are more limited in their ability to create or generate text as the output 116 (when compared with the two tier generative LLM architecture described above).

For example, the encoders can allow the discriminative LLMs 104 to understand text, but a limited ability to generate text. The discriminative LLMs 104 can identify semantic patterns in the input 112, cluster similar patterns in the input 112 and the labeled data 108, and draw distinctions between the input 112 and the labeled data 108. The labels in the training data 108 and the labels used to associate (or differentiate) clusters or patterns in the input 112 with the training data 108 may be restricted to those in a defined list or set 120. This can prevent other labels from being used. Restricting the labels that are usable by the discriminative LLMs 104 can stop or help prevent the discriminative LLMs 104 from outputting the secret or confidential information used to train the discriminative LLMs 104.

The training data 108 can include clusters of similar or related information or patterns from maintenance logbooks, technical manuals, or the like, with the clusters classified using the labels from the restricted list 120. The discriminative LLMs 104 can review the input 112 in the assigned task 114, search for similar clusters or patterns in the training data 108, label clusters or patterns in the input 112 using the labels in the list 120 based on the similar clusters or patterns in the training data 108, and provide the labeled clusters or patterns back to the generative LLM 102 as the output 116.

The labels in the restricted list 120 may include component identifiers, condition identifiers, location identifiers, and action-taken identifiers. The component identifiers may label the input 112 according to which components are identified in the input 112 and/or similar to the labeled training data 108. The component identifiers can include names, model numbers, or the like, of different components (e.g., brake, brake pin, main landing gear brake, flight recorder, tire, electronic flight bag, audio control panel, exterior passenger doors, etc.). The condition identifiers can indicate the state, health, or condition of the components (e.g., healthy, worn, missing, fault or failed, deteriorated, etc.). The location identifiers can indicate where the components are in the powered system. For example, the location identifiers can identify which tire is referenced in the input 112, which brake is referenced in the input 112, etc. The action-taken identifiers can identify previous actions performed on components in the training data 108, such as whether components were replaced, added, removed, serviced, etc.

Using only the labels in the restricted list 120 allows the discriminative LLMs 104 to provide increased confidence in each assigned label (when compared with generative LLMs 102 that may use any label and may not be restricted to labels in a restricted list). Confidence in the labels used for identifying similarities between the input 112 and the labeled data 108 can be increased as the accuracy of the labels assigned to the input 112 can be more easily measured.

The accuracy of each label that is applied can be independently measured from a test set of responses. For example, the accuracy of the discriminative LLM 104 identifying metaphors in literature, identifying maintenance deferrals in labeled record sets, etc. can be measured by a human checking or verifying whether a label assigned by the discriminative LLMs 104 in the test set is correct or incorrect. Because the number of labels used is limited by the list 120, the accuracy of application of the labels can be more easily determined when compared to using any label (including those outside of the list 120). In contrast, generative LLMs are not limited to the labels in a defined list 120, and therefore may create many other labels that need to be individually examined to determine whether the labels are accurate. Based on the accuracy of the labels applied by the discriminative LLMs 104 in the test sets, feedback can be provided to the discriminative LLMs 104 to re-train or fine-tune the discriminative LLMs 104, as described herein.

Additionally, restricting the labels available to the discriminative LLMs 104 can increase security. The discriminative LLMs 104 can be trained on a vast amount of sensitive corpora (e.g., the training data 108), but are unable to provide any answer that is outside the finite list 120 of labels available to the discriminative LLMs 104. This multi-agent AI system 100 can embed all training information and knowledge in the discriminative LLMs 104 and train classifiers (or other supervised or semi-supervised embodiments) to provide the foundational brickwork to any legitimate and reasonable prompt. For example, the AI system 100 can answer questions concerning the statistical maintenance history of a stealth fighter aircraft with expert confidence but without revealing any technical details. The technical documentation regarding the maintenance history can be provided to the discriminative LLMs 104, which can train classifiers that will label maintenance records according to approved and legitimate labels from the restricted, defined list described above. The generative LLM 102 can be a generic generative LLM 102 (such as GPT4, Mistral, OpenELM, etc.), which can interpret the prompt and answer the prompt based on the discriminatively labeled data set provided by the discriminative LLMs 104. The generative LLM 102 is unable to reveal any secret or confidential information because the generative LLM 102 is never in possession of any such information.

The AI system 100 optionally includes one or more additional LLMs 122. The additional LLM(s) 122 can provide additional functionality to the AI system 100. For example, the additional LLM(s) 122 can translate languages of documents, maintenance logs, etc. to the language of the user providing the prompt or query, or can retrieve documents for presentation to the user in response to the prompt or query 112.

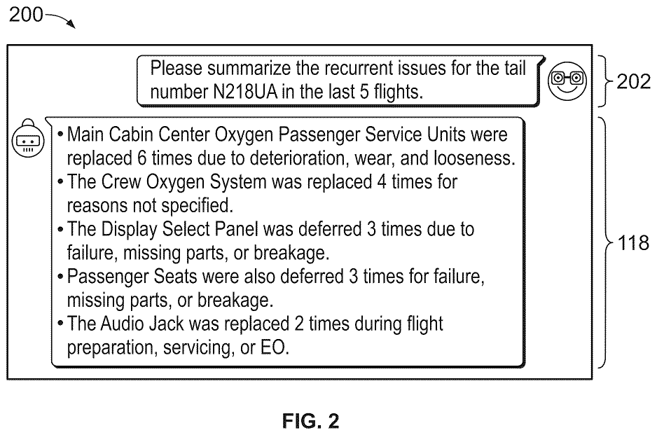

With continued reference to the AI system 100 shown in FIG. 1, FIG. 2 illustrates one example of operation of the AI system 100 via a GUI 200 presented to a user on the computer interface 106. The GUI 200 includes a display of the input 112, which can be a prompt asking for repeated issues or faults with components onboard an aircraft identified by tail number N218UA. The generative LLM 102 can examine the prompt in the input 112, and determine that the maintenance history tool is to be used for responding to the prompt. The generative LLM 102 can select the maintenance history tool due to the prompt asking about recent issues for an identified aircraft. The generative LLM 102 can determine that usage of “recent” and “5 flights” indicates that only information from the maintenance logs that is dated or was entered for the prior five flights of the aircraft is to be provided, and that usage of “issues” indicates that the maintenance logs are to be examined. The generative LLM 102 can then assign tasks to the discriminative LLM(s) 104 having access to the maintenance logs for that aircraft.

The discriminative LLM(s) 104 can then review the input 112, convert the input 112 into tokens of similar or related text, and compare the tokens from the input 112 with tokens of the training data 108. Similar tokens (e.g., in vector space of the discriminative LLM(s) 104) between the input 112 and the training data 108 can be identified using the labels applied by the discriminative LLM(s) 104. The discriminative LLM(s) 104 can generate output 116 that responds to the prompt. This output 116 also can include the labels from the restricted list 120 as applied by the discriminative LLM(s) 104.

The generative LLM 102 receives the output 116 from the discriminative LLM(s) 104. The generative LLM 102 decides which pattern of several different defined patterns to use in presenting the output 116 as the response 118 that is presented to the user or personnel via the interface 106. In the illustrated example, the maintenance history tool was used by the generative LLM 102, so the generative LLM 102 presents a list summarizing the maintenance logbooks for aircraft N218UA from the prior five flights of the aircraft, as shown in FIG. 2.

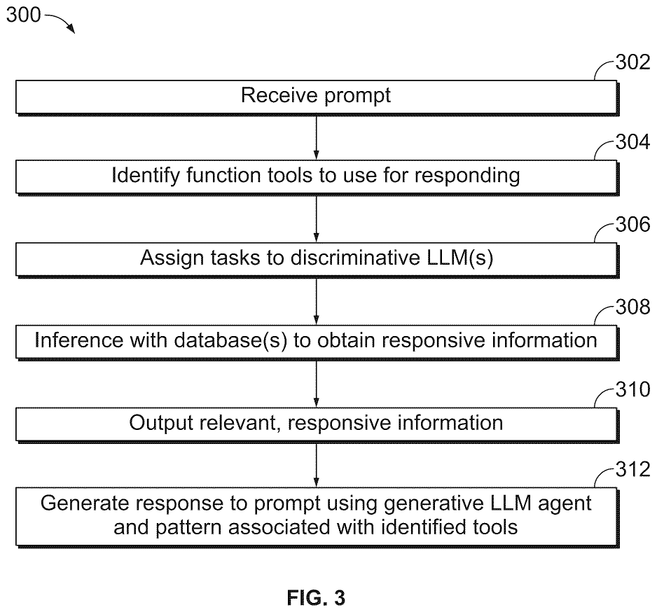

FIG. 3 illustrates a flowchart of one example of a method 300 for operation of an AI system. The method 300 can represent operations performed by the AI system 100. At 302, a prompt is received from a user. The prompt may request information on maintenance histories, guidance or information for performing maintenance on or inspecting one or more components of a powered system (e.g., an aircraft), or the like. At 304, a generative LLM examines the prompt and identifies one or more function tools to be used to obtain information responsive to the prompt. For example, the generative LLM can determine which component is referenced in the prompt, what result the prompt seeks (e.g., a maintenance action, determining a location of a component, etc.), etc. From these determinations, the generative LLM can select the appropriate function tools to obtain the information.

At 306, the generative LLM assigns tasks to one or more discriminative LLMs. Where there are several discriminative LLMs, the generative LLM can determine which discriminative LLM(s) were trained on data relative to the function tools identified at 304. Alternatively, the information stored in the memory or database 110 can be examined or run against the discriminative LLMs prior to releasing the system 100. This can help quickly identify the discriminative LLMs that are to be used for responding to different prompts prior to release of the system 100. This can reduce the time needed for deciding which of the generative LLM(s) a task is to be assigned.

At 308, the discriminative LLMs that receive the tasks from the generative LLM inferences with the database (this could be maintenance histories, technical manuals, or other narratives) and enriches the database with additional labels and/or content from a pre-designed restrictive list. For example, the discriminative LLMs can output information from the database(s) that respond to the tasks assigned to the discriminative LLMs.

At 310, the discriminative LLMs output the relevant information to the generative LLM. At 312, the generative LLM creates a response using the information output by the discriminative LLMs. The generative LLM may select a pattern for providing the response based on the function tool(s) identified at 304. For example, some function tools may be associated with a list or table, while others may be associated with a prose summary of information in logbooks. The generative LLM can present the information provided by the discriminative LLMs in the pattern that is associated with the identified tool(s).

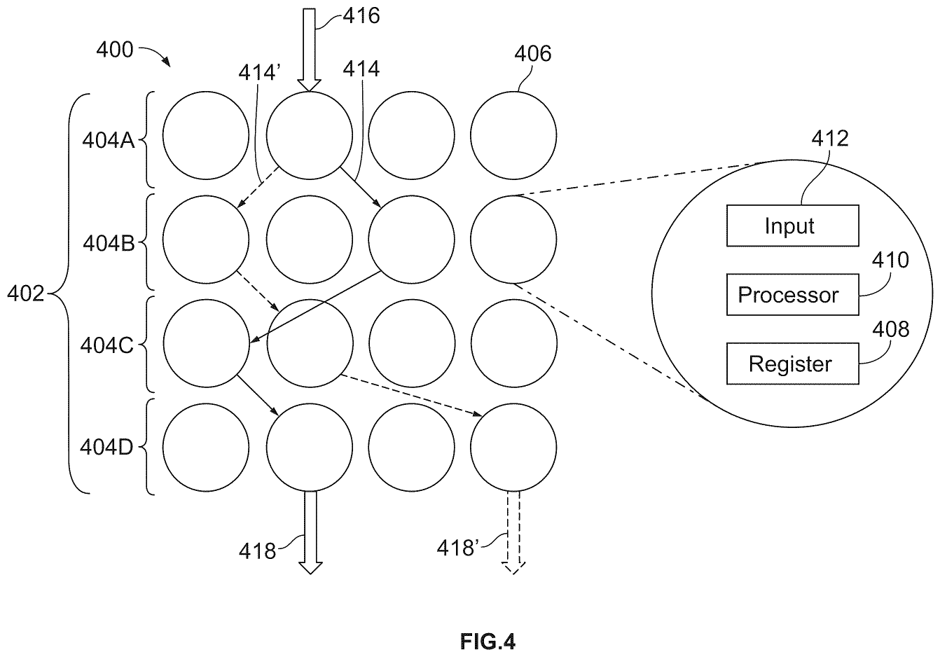

FIG. 4 illustrates one example of an LLM 400. The LLM 400 can represent one or more (or each) of the LLMs 102, 104 shown in FIG. 1. The LLM 400 includes a series 402 of layers 404A-D, each comprising one or more artificial neurons 406 arranged in one or more neuron arrays or arrangements. While four neurons 406 are shown in each layer 404A-D and four layers 404A-D are shown, alternatively, a different number of neurons 206 may be in one or more of the layers 404A-D and/or there may be a different number of layers 404A-D.

The LLM 400 may include the neurons 406 arranged in an input layer 404A, an output layer 404D, and two or more fully connected hidden or intermediate layers 404B, 404C between the input and output layers 404A, 404D. Each neuron 406 can include or represent a register 408, a microprocessor 410, and at least one input 412. The neurons 406 generate outputs based on one or more activation functions. The neurons 406 receive input from another neuron 406 (e.g., the output from one neuron 406 is the input for another neuron 406). This input also can include a set of weights. The neurons 406 can be connected with each other via synaptic circuits 414, 414′. The synaptic circuits 414, 414′can include or represent memories for storing synaptic weights.

One or more neurons 406 in the input layer 404A of the LLM 400 can receive an input 416 into the LLM 400. These neurons 406 can receive this input via the input(s) 412 of those neurons 406 in the input layer 404A. The neurons 406 receive the input, apply one or more mathematical equations or relationships stored in the registers 408 (and that include the weights) to generate an output. The processors 410 of the neurons 406 apply the equations/relationships. The processors 410 of the neurons 406 pass that output to another neuron 406 in the same layer 404A or in a different layer 404B, 404C. The output from one neuron 406 is passed along a synaptic circuit 414 to another neuron 406 and is used as input to this other neuron 406. This process continues until one or more neurons 406 in the output layer 404D generate an output 418 from the LLM 400.

The LLM 400 may be an artificial neural network (ANN), such as machine learning language model. The LLM 400 can be realized through software, hardware, or a combination of software and hardware. In some examples, the LLM 400 may be implemented by one or more application-specific integrated circuits (ASICs). ASICs may be specially customized for a specific artificial intelligence application and provide superior computing capabilities and reduced electricity consumption compared to traditional computers.

During training of the generative LLM 102, prompts that are labeled with function tools can be used as training data. These prompts and function tools can be provided as input 416 to the generative LLM 104. The neurons 406 learn to associate different tools with different prompts. Additional prompts (unlabeled or labeled) can be provided to the generative LLM 102, and the tools identified by the generative LLM 102 for use in responding to the prompts can be examined. Feedback can be provided to the generative LLM 102 in the form of an error or other indication of the inaccuracy (or accuracy) of the tool(s) identified by the generative LLM 102 for different prompts. Based on this error, the neurons 406 can change one or more of the synaptic circuits 414 that connect the neurons 406 and/or the weights applied by one or more of the neurons 406. For example, some synaptic circuits 414 can be changed to modified synaptic circuits 414′ such that the same prompt as input 416 would result in different neurons 406 receiving input and passing output to other neurons and generating a different output 418′ (e.g., a different function tool or set of tools) from the generative LLM 102.

During a subsequent iteration of operation of the generative LLM 102, additional prompts can be provided to the neurons 406 as the input 416 into the input layer 404A, and the neurons 406 can process the input data again to generate a labeled output 418′ from the generative LLM 102. The output 418′ is again examined for error in which tools are identified, and can be provided back to the generative LLM 102 to continue modifying and refining (e.g., training or re-training) the relationships between the neurons 406 (e.g., the synaptic circuits 414) and/or the weights applied by the neurons 406 to improve the identification of the proper function tools for responding to different prompts. For example, the generative LLM 102 may be trained and re-trained using backpropagation, which can involve adjusting model parameters (e.g., synaptic circuits 414 and/or weights) using calculated derivatives to minimize the loss function (e.g., the error). The backpropagation can be a mathematical calculation for supervised learning of the generative LLM 102 using gradient descent. Backpropagation can be used to calculate the gradient of the error function with respect to the weights of the generative LLM 102.

During training of the discriminative LLM 104, the labeled training data 108 may be provided as input 416 to the discriminative LLM 104. The neurons 406 process the input data to generate the output of the discriminative LLM 104. As described above, the training data and the output from the discriminative LLM 104 may be classified with labels from the restricted list 120 of labels. The labeled output from the discriminative LLM 104 can be examined to determine whether the labels used to classify the output are accurate or inaccurate. A label may be incorrectly applied (and therefore inaccurate) if the label identifies the wrong component, wrong component location, wrong component condition, and/or wrong action to perform on the component.

Feedback can be provided to the discriminative LLM 104 in the form of a calculated error or other indication of the inaccuracy of the label(s) applied to the output from the discriminative LLM 104. Based on this error, the neurons 406 can change one or more of the synaptic circuits 414 that connect the neurons 406 and/or the weights applied by one or more of the neurons 406. For example, some synaptic circuits 414 can be changed to modified synaptic circuits 414′ such that the same input 416 would result in different neurons 406 receiving input and passing output to other neurons and generating a different output 418′ from the discriminative LLM 104. This different output 418′ can be, for example, different labels applied to the information.

During a subsequent iteration of operation of the discriminative LLM 104, additional labeled training data can be provided to the neurons 406 as the input 416 into the input layer 404A, and the neurons 406 can process the input data again to generate a labeled output 418′ from the discriminative LLM 104. The output 418′ is again examined for error in which labels are applied, and can be provided back to the discriminative LLM 104 to continue modifying and refining (e.g., training or re-training) the relationships between the neurons 406 (e.g., the synaptic circuits 414) and/or the weights applied by the neurons 406 to decrease the error of outputs from the discriminative LLM 104. For example, the discriminative LLM 104 may be trained and re-trained using backpropagation, which can involve adjusting model parameters (e.g., synaptic circuits 414 and/or weights) using calculated derivatives to minimize the loss function (e.g., the error). The backpropagation can be a mathematical calculation for supervised learning of the discriminative LLM 104 using gradient descent. Backpropagation can be used to calculate the gradient of the error function with respect to the weights of the discriminative LLM 400.

### Further, the Disclosure Comprises Examples According to the Following clauses:

Clause 1: An artificial intelligence system comprising: a generative large language model (LLM) configured to receive prompts related to maintenance of one or more components of a powered system, the generative LLM configured to identify one or more function tools to be used in searching for information responsive to the prompts; and one or more discriminative LLMs trained on maintenance logbooks and technical manuals associated with the one or more components of the powered system, the generative LLM configured to select from among the one or more discriminative LLMs to search for the information responsive to the prompts based on which of the one or more function tools are identified, the one or more discriminative LLMs that are selected configured to obtain the information responsive to the prompts and to provide the information to the generative LLM, the generative LLM configured to create and present responses to the prompts according to a pattern associated with the one or more function tools that are identified and using the responsive information.
Clause 2: The artificial intelligence system of Clause 1, wherein the generative LLM is configured to identify a component function tool as the one or more function tools responsive to the prompts, the one or more discriminative LLMs configured to one or more of obtain maintenance records of the one or more components, provide recent actions performed on the one or more components, or provide conditions of the one or more components.
Clause 3: The artificial intelligence system of Clause 1, wherein the generative LLM is configured to identify a condition function tool as the one or more function tools responsive to the prompts, the one or more discriminative LLMs configured to one or more of obtain the information on conditions of the one or more components during recent operation.
Clause 4: The artificial intelligence system of Clause 1, wherein the generative LLM is configured to identify an action function tool as the one or more function tools responsive to the prompts, the one or more discriminative LLMs configured to obtain actions or events performed during recent operation of the one or more components.
Clause 5: The artificial intelligence system of Clause 1, wherein the generative LLM is configured to identify a recurrent summary tool as the one or more function tools responsive to the prompts, the one or more discriminative LLMs configured to provide a frequency at which some event occurred involving the one or more components.
Clause 6: The artificial intelligence system of Clause 1, wherein the generative LLM is configured to identify a minimum equipment list summary tool as the one or more function tools responsive to the prompts, the one or more discriminative LLMs configured to provide one or more maintenance logbooks of the one or more components that are included in a minimum equipment list for an aircraft responsive to the minimum equipment list summary tool being identified.
Clause 7: The artificial intelligence system of Clause 1, wherein the generative LLM is configured to identify a sensor warning tool as the one or more function tools responsive to the prompts, the one or more discriminative LLMs configured to one or more of provide a characteristic measured by a sensor giving rise to a warning or alarm, historical values of sensor outputs, a history of the warning or alarm occurring, or one or more limits used by the sensor to determine when to output the warning or alarm.
Clause 8: The artificial intelligence system of Clause 1, wherein the generative LLM is configured to identify an estimated work time tool as the one or more function tools responsive to the prompts, the one or more discriminative LLMs configured to provide an estimated time to complete maintenance on the one or more components responsive to the estimated work time tool being identified.
Clause 9: A method comprising: receiving a prompt related to maintenance of one or more components of a powered system, the prompt received by a generative large language model (LLM); identifying one or more function tools to be used in searching for information using the generative LLM, the one or more function tools identified based on the prompt; assigning one or more discriminative LLMs to search maintenance logbooks and technical manuals associated with the one or more components of the powered system based on the one or more function tools that are identified; creating a response to the prompt according to a pattern associated with the one or more function tools that are identified and using the responsive information.
Clause 10: The method of Clause 9, wherein the one or more function tools that are identified includes a component function tool, the one or more discriminative LLMs assigned to one or more of obtain maintenance records of the one or more components, provide recent actions performed on the one or more components, or provide conditions of the one or more components.
Clause 11: The method of Clause 9, wherein a condition function tool is identified as the one or more function tools, the one or more discriminative LLMs assigned to one or more of obtain the information on conditions of the one or more components during recent operation.
Clause 12: The method of Clause 9, wherein an action function tool is identified as the one or more function tools, the one or more discriminative LLMs assigned to obtain actions or events performed during recent operation of the one or more components.
Clause 13: The method of Clause 9, wherein a recurrent summary tool is identified as the one or more function tools, the one or more discriminative LLMs assigned to provide a frequency at which some event occurred involving the one or more components.
Clause 14: The method of Clause 9, wherein a minimum equipment list summary tool is identified as the one or more function tools, the one or more discriminative LLMs assigned to provide one or more maintenance logbooks of the one or more components that are included in a minimum equipment list for an aircraft.
Clause 15: The method of Clause 9, wherein a sensor warning tool is identified as the one or more function tools, the one or more discriminative LLMs assigned to one or more of provide a characteristic measured by a sensor giving rise to a warning or alarm, historical values of sensor outputs, a history of the warning or alarm occurring, or one or more limits used by the sensor to determine when to output the warning or alarm.
Clause 16: The method of Clause 9, wherein an estimated work time tool is identified as the one or more function tools, the one or more discriminative LLMs assigned to provide an estimated time to complete maintenance on the one or more components responsive to the estimated work time tool being identified.
Clause 17: An artificial intelligence system comprising: a generative large language model (LLM) configured to receive a prompt related to maintenance of a component of an aircraft, the generative LLM configured to identify a function tool to be used in searching for information responsive to the prompt; and one or more discriminative LLMs trained on maintenance logbooks and technical manuals associated with the component of the aircraft, the generative LLM configured to select from among the one or more discriminative LLMs to search for the information responsive to the prompt based on which of the one or more function tools are identified, the one or more discriminative LLMs configured to obtain the information responsive to the prompt using the function tool that is identified and to provide the information to the generative LLM.
Clause 18: The artificial intelligence system of Clause 17, wherein the generative LLM is configured to create and present a response to the prompt according to a designated pattern associated with the function tool that is identified and using the responsive information.
Clause 19: The artificial intelligence system of Clause 17, wherein the generative LLM is configured to identify a component function tool as the one or more function tools responsive to the prompts, the one or more discriminative LLMs configured to one or more of obtain maintenance records of the one or more components, provide recent actions performed on the one or more components, or provide conditions of the one or more components.
Clause 20: The artificial intelligence system of Clause 17, wherein the generative LLM is configured to identify a condition function tool as the one or more function tools responsive to the prompts, the one or more discriminative LLMs configured to one or more of obtain the information on conditions of the one or more components during recent operation.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. An artificial intelligence system comprising:
a generative large language model (LLM) configured to receive prompts related to maintenance of one or more components of a powered system, the generative LLM configured to identify one or more function tools to be used in searching for information responsive to the prompts; and
one or more discriminative LLMs trained on maintenance logbooks and technical manuals associated with the one or more components of the powered system, the generative LLM configured to select from among the one or more discriminative LLMs to search for the information responsive to the prompts based on which of the one or more function tools are identified, the one or more discriminative LLMs that are selected configured to obtain the information responsive to the prompts and to provide the information to the generative LLM, the generative LLM configured to create and present responses to the prompts according to a pattern associated with the one or more function tools that are identified and using the responsive information.

2. The artificial intelligence system of claim 1, wherein the generative LLM is configured to identify a component function tool as the one or more function tools responsive to the prompts, the one or more discriminative LLMs configured to one or more of obtain maintenance records of the one or more components, provide recent actions performed on the one or more components, or provide conditions of the one or more components.

3. The artificial intelligence system of claim 1, wherein the generative LLM is configured to identify a condition function tool as the one or more function tools responsive to the prompts, the one or more discriminative LLMs configured to one or more of obtain the information on conditions of the one or more components during recent operation.

4. The artificial intelligence system of claim 1, wherein the generative LLM is configured to identify an action function tool as the one or more function tools responsive to the prompts, the one or more discriminative LLMs configured to obtain actions or events performed during recent operation of the one or more components.

5. The artificial intelligence system of claim 1, wherein the generative LLM is configured to identify a recurrent summary tool as the one or more function tools responsive to the prompts, the one or more discriminative LLMs configured to provide a frequency at which some event occurred involving the one or more components.

6. The artificial intelligence system of claim 1, wherein the generative LLM is configured to identify a minimum equipment list summary tool as the one or more function tools responsive to the prompts, the one or more discriminative LLMs configured to provide one or more maintenance logbooks of the one or more components that are included in a minimum equipment list for an aircraft responsive to the minimum equipment list summary tool being identified.

7. The artificial intelligence system of claim 1, wherein the generative LLM is configured to identify a sensor warning tool as the one or more function tools responsive to the prompts, the one or more discriminative LLMs configured to one or more of provide a characteristic measured by a sensor giving rise to a warning or alarm, historical values of sensor outputs, a history of the warning or alarm occurring, or one or more limits used by the sensor to determine when to output the warning or alarm.

8. The artificial intelligence system of claim 1, wherein the generative LLM is configured to identify an estimated work time tool as the one or more function tools responsive to the prompts, the one or more discriminative LLMs configured to provide an estimated time to complete maintenance on the one or more components responsive to the estimated work time tool being identified.

9. A method comprising:
receiving a prompt related to maintenance of one or more components of a powered system, the prompt received by a generative large language model (LLM);
identifying one or more function tools to be used in searching for information using the generative LLM, the one or more function tools identified based on the prompt;
assigning one or more discriminative LLMs to search maintenance logbooks and technical manuals associated with the one or more components of the powered system based on the one or more function tools that are identified; and
creating a response to the prompt according to a pattern associated with the one or more function tools that are identified and using the responsive information.

10. The method of claim 9, wherein the one or more function tools that are identified includes a component function tool, the one or more discriminative LLMs assigned to one or more of obtain maintenance records of the one or more components, provide recent actions performed on the one or more components, or provide conditions of the one or more components.

11. The method of claim 9, wherein a condition function tool is identified as the one or more function tools, the one or more discriminative LLMs assigned to one or more of obtain the information on conditions of the one or more components during recent operation.

12. The method of claim 9, wherein an action function tool is identified as the one or more function tools, the one or more discriminative LLMs assigned to obtain actions or events performed during recent operation of the one or more components.

13. The method of claim 9, wherein a recurrent summary tool is identified as the one or more function tools, the one or more discriminative LLMs assigned to provide a frequency at which some event occurred involving the one or more components.

14. The method of claim 9, wherein a minimum equipment list summary tool is identified as the one or more function tools, the one or more discriminative LLMs assigned to provide one or more maintenance logbooks of the one or more components that are included in a minimum equipment list for an aircraft.

15. The method of claim 9, wherein a sensor warning tool is identified as the one or more function tools, the one or more discriminative LLMs assigned to one or more of provide a characteristic measured by a sensor giving rise to a warning or alarm, historical values of sensor outputs, a history of the warning or alarm occurring, or one or more limits used by the sensor to determine when to output the warning or alarm.

16. The method of claim 9, wherein an estimated work time tool is identified as the one or more function tools, the one or more discriminative LLMs assigned to provide an estimated time to complete maintenance on the one or more components responsive to the estimated work time tool being identified.

17. An artificial intelligence system comprising:
a generative large language model (LLM) configured to receive a prompt related to maintenance of a component of an aircraft, the generative LLM configured to identify a function tool to be used in searching for information responsive to the prompt; and
one or more discriminative LLMs trained on maintenance logbooks and technical manuals associated with the component of the aircraft, the generative LLM configured to select from among the one or more discriminative LLMs to search for the information responsive to the prompt based on which of the one or more function tools are identified, the one or more discriminative LLMs configured to obtain the information responsive to the prompt using the function tool that is identified and to provide the information to the generative LLM.

18. The artificial intelligence system of claim 17, wherein the generative LLM is configured to create and present a response to the prompt according to a designated pattern associated with the function tool that is identified and using the responsive information.

19. The artificial intelligence system of claim 17, wherein the generative LLM is configured to identify a component function tool as the one or more function tools responsive to the prompts, the one or more discriminative LLMs configured to one or more of obtain maintenance records of the one or more components, provide recent actions performed on the one or more components, or provide conditions of the one or more components.

20. The artificial intelligence system of claim 17, wherein the generative LLM is configured to identify a condition function tool as the one or more function tools responsive to the prompts, the one or more discriminative LLMs configured to one or more of obtain the information on conditions of the one or more components during recent operation.
